(19) United States
(12) Patent Application Publication
(10) Pub. No.: US 2014/0059146 A1
(43) Pub. Date: Feb. 27, 2014

(54) USE OF BACKCHANNEL WITH DATACASTING VIA BROADCAST MEDIUM

(71) Applicant: TV Band Service, LLC, Wilmington, NC (US)

(72) Inventors: Donald C. RICH, Jr., Wrightsville Beach, NC (US); Paul Allen SADOWSKI, Apex, NC (US); Keith W. BOLICK, Wilmington, NC (US)

(73) Assignee: TV Band Service, LLC, Wilmington, NC (US)

(21) Appl. No.: 13/973,724

(22) Filed: Aug. 22, 2013

Related U.S. Application Data
(60) Provisional application No. 61/693,236, filed on Aug. 24, 2012.

(51) Int. Cl. H04L 12/58

(52) U.S. Cl. CPC H04L 51/30
USPC 709/206

(57) ABSTRACT

Expansion of unidirectional datacasting includes the use of backchannel communication link(s) for clients communication with the datacasting infrastructure, producing a closed-loop or bidirectional system, possibly for both the acknowledgement of datacasting message receipts and a request-response service over datacasting. In one implementation, a server creates a message including a data object and a data object identifier associated with the data object. The server datacasts the message via the broadcast medium to client device(s). A given client device receives the message datacasted by the server via the broadcast medium, creates a given message including the data object identifier, and sends the given message to the server via a given backchannel. The server receives the given message including the data object identifier from the given client device via the given backchannel and records the receipt of the given message for the data object identifier.

### CROSS-REFERENCE TO RELATED APPLICATIONS

This application claims priority to: co-pending U.S. provisional application Ser. No. 61/693,236, filed on Aug. 24, 2012; and co-pending U.S. patent application Ser. No. 13/892,344, filed on May 13, 2013, which claims priority to U.S. provisional application Ser. No. 61/646,960, filed on May 15, 2012.

### BACKGROUND OF THE INVENTION

In a data delivery system, data objects may be datacast from a server to one or more client devices over a communications medium. Datacasting is often understood to be a one-way delivery of data objects, i.e., delivery from the server to the client. However, with a one-way delivery such as datacasting, the server receives no information from the client concerning receipt of the data object, nor whether the data objects is wanted by the client.

### BRIEF SUMMARY OF THE INVENTION

According to one embodiment of the present invention, a server creates a message comprising a data object and a data object identifier associated with the data object and datacasts the message via a broadcast medium to one or more client devices. The server receives one or more messages comprising the data object identifier from one or more client of the devices via one or more backchannels and records receipt of the one or more messages for the data object identifier.

In one aspect of the present invention, a given client receives the message datacasted by the server via the broadcast medium, processes the message, creates a given acknowledgment message comprising the data object identifier, and sends the given acknowledgment message to the server via a given backchannel.

In one aspect of the present invention, the given client device creates a request comprising the data object identifier and sends the request to the server via a given backchannel.

In one aspect of the present invention, the server receives the request comprising the data object identifier from the given client device via the given backchannel, processes the request based on the data object identifier, and creates the message comprising the data object associated with the data object identifier and the data object identifier as a response to the request.

In one aspect of the present invention, the server determines a given response generator to provide the request based on information comprised in the request and any rules stored at the server.

In one aspect of the present invention, the server enters a record with the data object identifier into a server store with an acknowledgment count set to an initial value, and in response to receiving a given acknowledgment message from a given client device, incrementing the acknowledgment count.

In one aspect of the present invention, the one or more acknowledgment messages further comprise an identifier associated with the given client device. The server logs that the acknowledgment message was received from the given client device.

### BRIEF DESCRIPTION OF THE SEVERAL VIEWS OF THE FIGURES

FIG. 1 illustrates a system combining a datacasting service over a broadcast communications medium with one or more request channels or backchannels to create a unique closed-loop communications system, according to embodiments of the present invention.

FIG. 2 illustrates a computing system according to embodiments of the present invention.

FIG. 3A illustrates the requesting of data objects by a client device using one or more backchannels according to embodiments of the present invention.

FIG. 3B illustrates the datacasting of data objects by the server according to embodiments of the present invention.

FIG. 4A illustrates the receiving of datacasted messages by a client device according to embodiments of the present invention.

FIG. 4B illustrates the server receiving the acknowledgment message via a backchannel according to embodiments of the present invention.

FIG. 5A illustrates in more detail the receiving of datacasted messages by the client devices according to embodiments of the present invention.

FIG. 5B illustrates in more detail the sending of an acknowledgment messages by the client devices via an available backchannel according to embodiments of the present invention.

FIG. 6A illustrates in more detail the datacasting of requested data objects by the server to client device(s) according to embodiments of the present invention.

FIG. 6B illustrates in more detail the receiving of acknowledgment messages by the server from client device(s) via an available backchannel according to embodiments of the present invention.

FIG. 7 illustrates in more detail a system combining a datacasting service over a broadcast communications medium with one or more backchannels according to embodiments of the present invention.

FIG. 8 illustrates a method for determining whether a sender should be (re)-selected and tuning to that seconder according to embodiments of the present invention.

FIGS. 9A-9D illustrate exemplary conditions for determining that a sender should be selected according to embodiments of the present invention.

FIGS. 10A-10D illustrate further examples for determining that a sender should be selected according to embodiments of the present invention.

FIG. 11 illustrates a method for determining the selection of a sender according to embodiments of the present invention.

FIGS. 12A-D illustrate exemplary conditions for step 1140 of FIG. 11 according to embodiments of the present invention.

### DETAILED DESCRIPTION OF THE INVENTION

The following description is presented to enable one of ordinary skill in the art to make and use the present invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

The present invention can take the form of an entirely hardware embodiment, an entirely software embodiment or an embodiment containing both hardware and software elements. In a preferred embodiment, the present invention is implemented in software, which includes but is not limited to firmware, resident software, microcode, etc.

Furthermore, the present invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, point devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

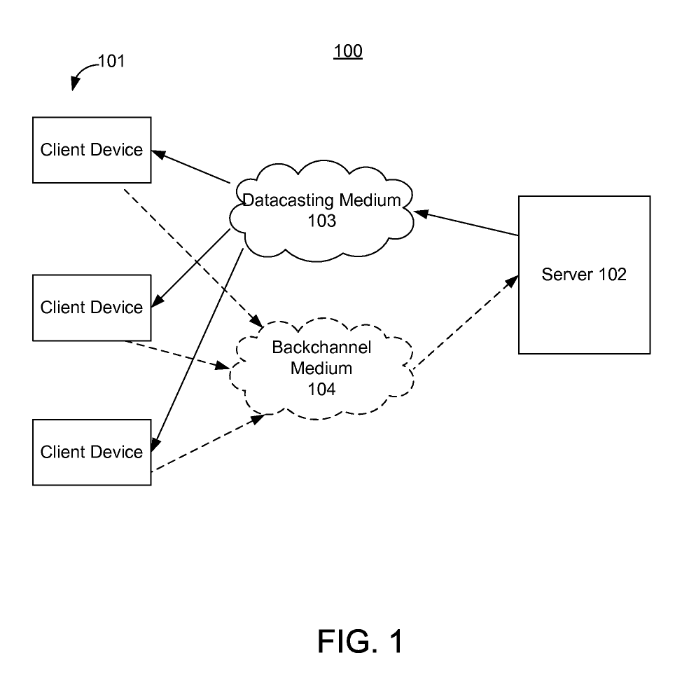

FIG. 1 illustrates a system combining a datacasting service over a broadcast communications medium with one or more request channels or backchannels to create a unique closed-loop communications system, according to embodiments of the present invention. The system 100 includes one or more client devices 101 receiving data objects via datacasting 103 and storing communications to be sent via an available backchannel 104. The server 102 receives communications from the client device(s) 101 when the backchannel 104 provides them to the server 102. Further, a backchannel 104 can be used by a client device 101 to request that data objects be datacast by the server 102, and a backchannel message from the client device 101 may be used to convey an acknowledgment of receipt to the server 102. The acknowledgment message may indicate that a data object was processed successfully (or not) by the client device 101. The server 102 then datacasts the requested data objects as a response to the request. The response may be received exclusively by the requesting client device and/or other client devices in the broadcast area. In this embodiment, the datacasting medium 103 is a broadcast communications medium, such as a digital television (DTV) signal. The data objects are encoded in a portion of the DTV signal, and the signal may be received by a client device 101 equipped with an appropriate DTV receiver. The system 100 uses metadata of the data objects to deliver a data object to the desired client devices 101 and to specify what actions the client devices 101 should take upon receiving the data object. One example datacasting system is disclosed in U.S. patent application Ser. No. 13/019,627, filed on Feb. 2, 2011, issued as U.S. Pat. No. 8,503,925 on Aug. 6, 2013, incorporated herein by reference. However, other types of datacasting systems may be used.

In the system 100, a second communication medium, referred to herein as the “backchannel” medium 104 is combined with the datacasting medium 103 to create a closed-loop communications system. For example, an internet protocol can be supported by transmitting internet packets in one direction using the datacasting medium (from the server 102) to a receiver (client device 101), and transmitting internet packets in the reverse direction via a separate backchannel. The backchannel may be of any sort, such as a land-line phone data connection; a cellular data connection; digitally encoded data transmitted via LMRS; a physical medium such as data on transportable storage; civilian or semi-civilian media such as Amateur Radio, Citizens Band, or MARS using FSK, Morse code, or voice; near-field communications; or other means. The backchannel may be real-time and continually available, be non-real-time, or be intermittently available. The backchannel may be comprised of multiple sorts of mediums, including but not limited to a WIFI connection to the internet, a removable storage medium, or voice communications translated by an operator at a workstation. Neither the server 102 nor any of the client devices 101 need be an appliance.

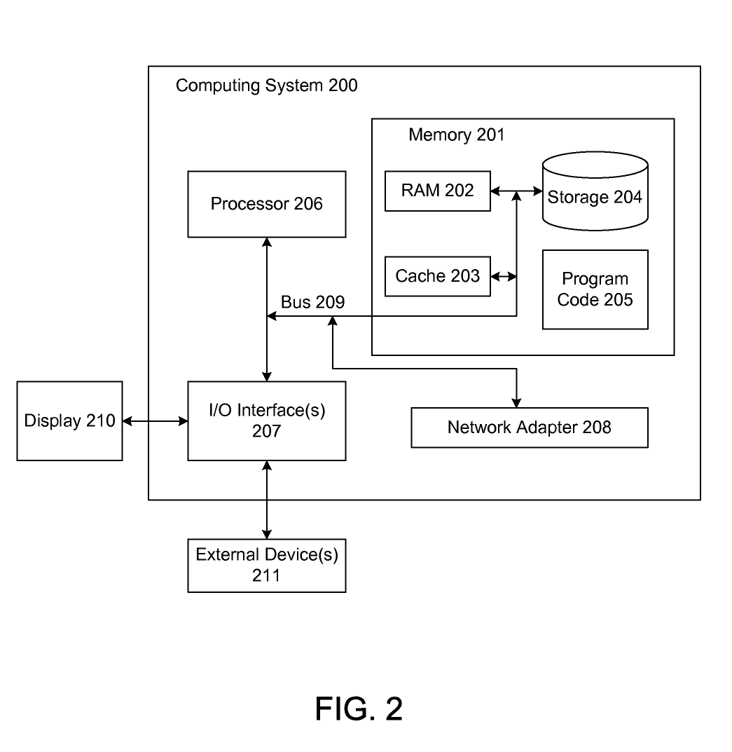

In the system 100, each client device 101 and/or the server 102 are computing systems or devices, as illustrated in FIG. 2, according to embodiments of the present invention. The computing system 200 is operationally coupled to a processor or processing units 206, a memory 201, and a bus 209 that couples various system components, including the memory 201 to the processor 206. The bus 209 represents one or more of any of several types of bus structure, including a memory bus or memory controller, a peripheral bus, an accelerated graphics port, and a processor or local bus using any of a variety of bus architectures. The memory 201 may include computer readable media in the form of volatile memory, such as random access memory (RAM) 202 or cache memory 203, or non-volatile storage media 204. The memory 201 may include at least one program product having a set of at least one program code module 205 that are configured to carry out the functions of embodiment of the present invention when executed by the processor 206. The computing system 200 may also communicate with one or more external devices 211, such as a display 210, via I/O interfaces 207. The computing system 200 may communicate with one or more networks via network adapter 208.

Possible uses of a backchannel include supporting other communications or sorts of messages, such as messages to request files or data objects. Further possible uses of a backchannel also include permitting a client to acknowledge successful delivery of packets or data objects, or to request re-transmission of packets or data objects. For example, if a server has receives an indication that a data object or packet has not been received successfully, it may re-transmit the data object or packet. Other possible uses include communicating status of an operation or event that may or may not be associated with a data object that has been datacast. For example, a backchannel may be used to send a message that a particular data object or file, after being received, was also displayed for a user to read.

In some applications, the backchannel need not be in real-time or available continually, such as, for example, in educational applications where knowing at the end of the day whether a school received teaching materials sent by datacasting may be all that is required, and in a natural disaster where it may be useful just to know after a period of hours that a significant portion of receivers have received the data. Similarly, for requesting materials to be datacast, it may be satisfactory if the request is received before the start of the next class day or week. Thus, in some embodiments, intermittent or non-real-time backchannels may be used

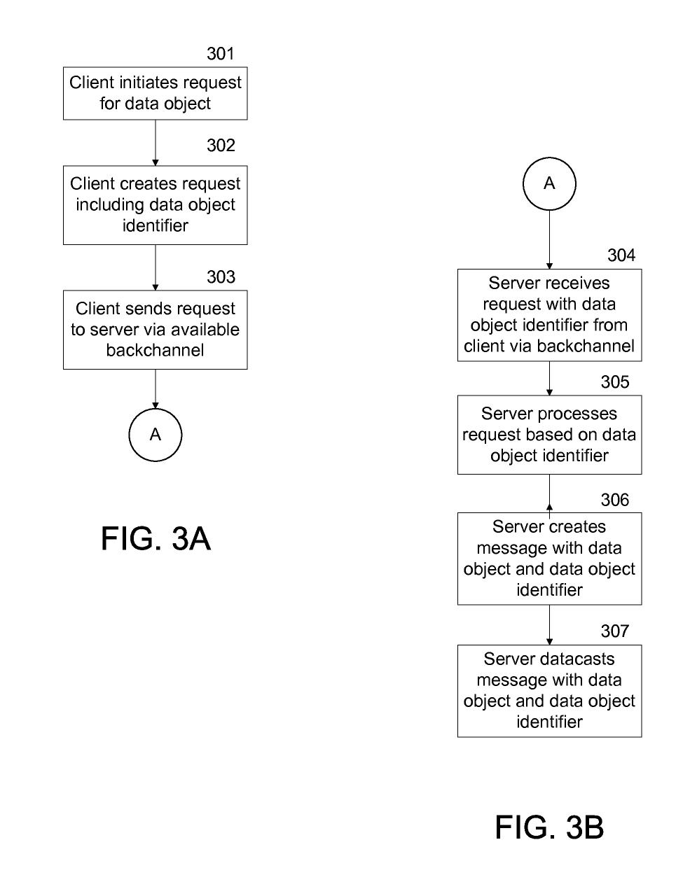

FIG. 3A illustrates the requesting of data objects by a client device using one or more backchannels according to embodiments of the present invention. The client 101 initiates a request for a data object (301). In response, the client 101 creates a request that includes a unique identifier for the data objects (302). The request is then sent to the server 102 via an available backchannel 104 (303). FIG. 3B illustrates the datacasting of data objects by the server according to embodiments of the present invention. The server 102 receives the request with the data object identifier from the client 101 via a backchannel 104 (304). The server 102 processes the request based on the data object identifier (305). The server 102 generates a message that includes the data object (306), and datacasts the message with the data object, along with the data object identifier (307). Alternatively, data objects may be configured and/or scheduled to be datacast to one or more client devices 101 without the receipt of a request from a client device 101.

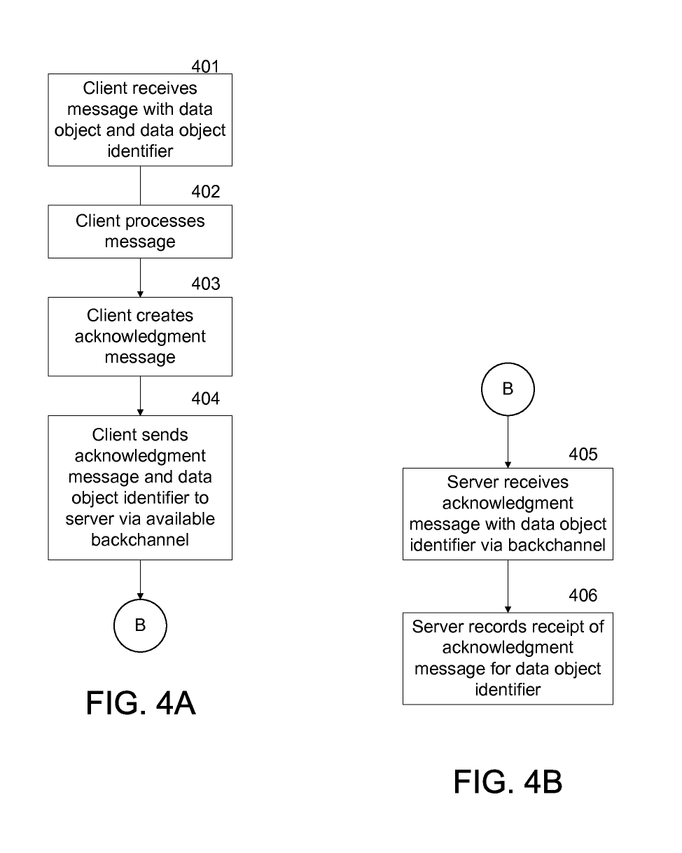

FIG. 4A illustrates the receiving of datacasted messages by a client device according to embodiments of the present invention. When a client device 101 receives the message with the data object and the data object identifier (401) datacasted by the server 102, the client device 101 processes the message (402) and creates an acknowledgment message (403). The client device 101 sends the acknowledgment message and the data object identifier to the server 102 via an available backchannel 104 (404). FIG. 4B illustrates the server receiving the acknowledgment message via a backchannel according to embodiments of the present invention. The server 102 receives the acknowledgment message and the data object identifier from the client device 101 via the backchannel 104 (405). The server 102 then records the receipt of the acknowledgment message for the data object identifier (406).

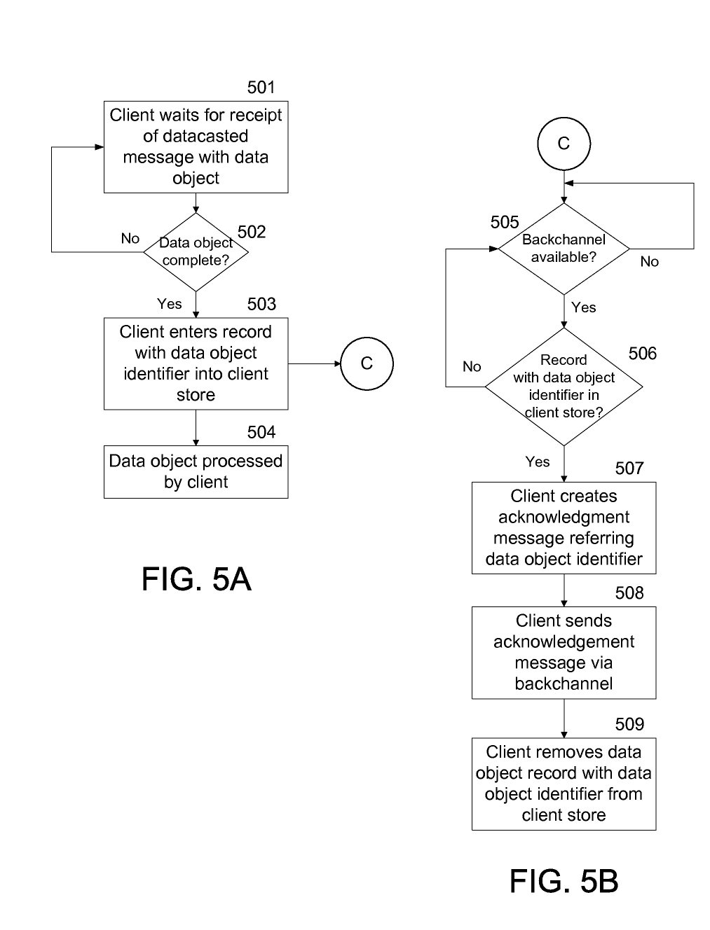

FIG. 5A illustrates in more detail the receiving of datacasted messages by the client devices according to embodiments of the present invention. FIG. 5B illustrates in more detail the sending of an acknowledgment messages by the client devices via an available backchannel according to embodiments of the present invention. A client device 101 waits for a message with a data object and metadata—including a data object identifier, to be received via datacasting from the server 102 (501). If the current data object is not yet completely received, processing continues back to 501 as shown. If the current data object has been completely received (502), the client device 101 enters a record with the data object identifier to a data store accessible to the client device 101 (503). The client device 101 processes the data object (504). A concurrent set of steps are shown in FIG. 5B. When a backchannel is available (505), the client device 101 reads the data object identifier from the data store (506). If there are no records with data object identifiers to read, processing returns to step 505. If a record is read, the client device 101 creates an acknowledgment message referencing the data object identifier (507). The client device 101 sends the acknowledgment message via the backchannel 104 for delivery to the server 102 and the data object identifier is removed from the data store (508).

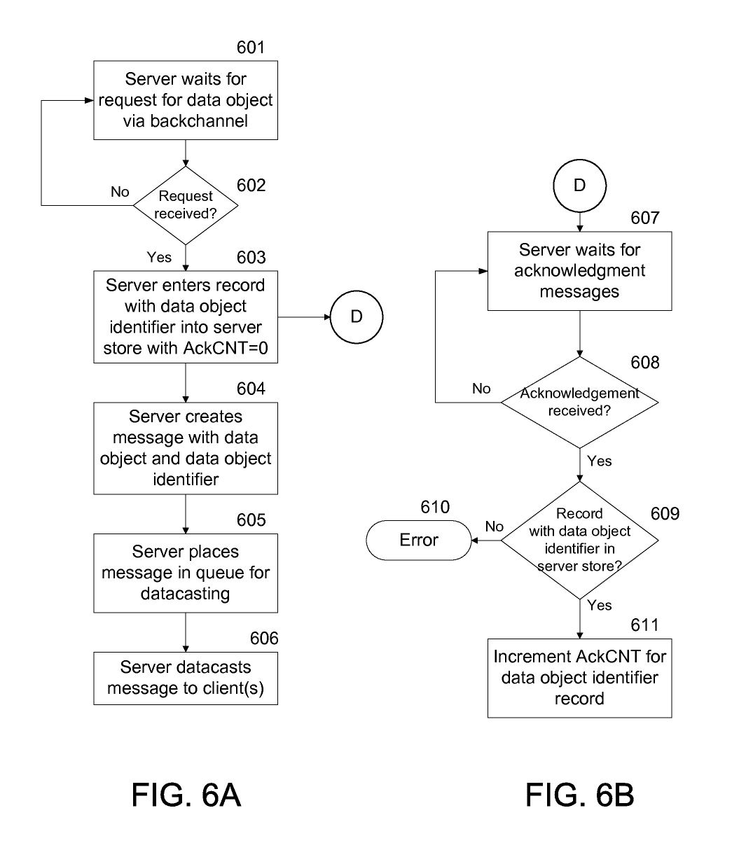

FIG. 6A illustrates in more detail the datacasting of requested data objects by the server to client device(s) according to embodiments of the present invention. FIG. 6B illustrates in more detail the receiving of acknowledgment messages by the server from client device(s) via an available backchannel according to embodiments of the present invention. The server 102 waits for receipt of a request for a data object from a client device 101 via a backchannel 104 (601). In this embodiment, the request is a data structure referencing a data object to be datacast and metadata information of the data object. If a request is not received, or if a received request is not valid (e.g. the referenced data object does not exist), processing returns to step 601. If a request is received, the server 102 enters a record with the data object identifier into a store accessible to the server 102, along with an ACKCNT value of zero (603). In this embodiment, the ACKCNT represents the number of acknowledgment messages received from client devices acknowledging receipt of the data object. The server 102 creates a message with the data object and the data object identifier (604). The server 102 places the message in a queue for datacasting (605). The message is datacast (606), possibly targeted to certain client device(s).

Referring to FIG. 6B, the server 102 waits to receive acknowledgment messages (607). When an acknowledgment message is received via a backchannel (608), the server 102 determines whether the data object identifier referenced in the acknowledgment message is present in a record in the server store (609). If not, this is an error condition (610). Handling of the error is a matter of implementation choice, for example ignoring the acknowledgment message, logging the message, or a more complex handling. If the acknowledgment message is valid, the ACKCNT value for the data object identifier is incremented, indicating that the data object was received by a client device successfully. The ACKCNT thus indicates the number of client devices 101 that has successfully received the data object.

The form of the data object identifier may be chosen as a matter of design choice, such as a generated value (for example a GUID) or a calculated ID such as a hash of the data of the data object. The identifier may also be relatively unique, such as a sequential ID generated by a particular server or in a particular context. Data object identifiers may be created at different steps as a matter of implementation choice, for example they may be generated when a data object is datacast, or may be associated with the request for the data object beforehand.

Concurrent steps may be carried out in various forms as a matter of implementation choice, for example in separate processes, tasks, co-routines, or processors, or they may also be performed in a sequential or alternating fashion.

Back channel communications may also employ multiple backchannels as a matter of implementation choice: for example, as a primary communications medium and one or more backup media, preferentially, or in another fashion. Waiting may be implemented in various fashions as a matter of implementation choice, such as use of an interrupt signal, status polling, a timer, implicitly, or busy-waiting.

Additional information may be stored in the stores, or be present in the metadata or messages. For example, an acknowledgment message sent by a client device 101 may include an identifier of the client device 101, and the server 102 may log which client device 101 has acknowledged receiving the data object.

The information collected in the server store may be used for any further purposes as a matter of implementation choice. For example, once a data object has been acknowledged as received by a number or portion of the intended client devices, it may be removed from a datacasting queue or not datacast further, or it may be datacast less often, thus freeing up datacasting resources. If a desired criterion for acknowledgments is not attained in a period of time for a particular data object, or a client device does not acknowledge a sufficient portion of data objects received, an error condition or signal may be generated.

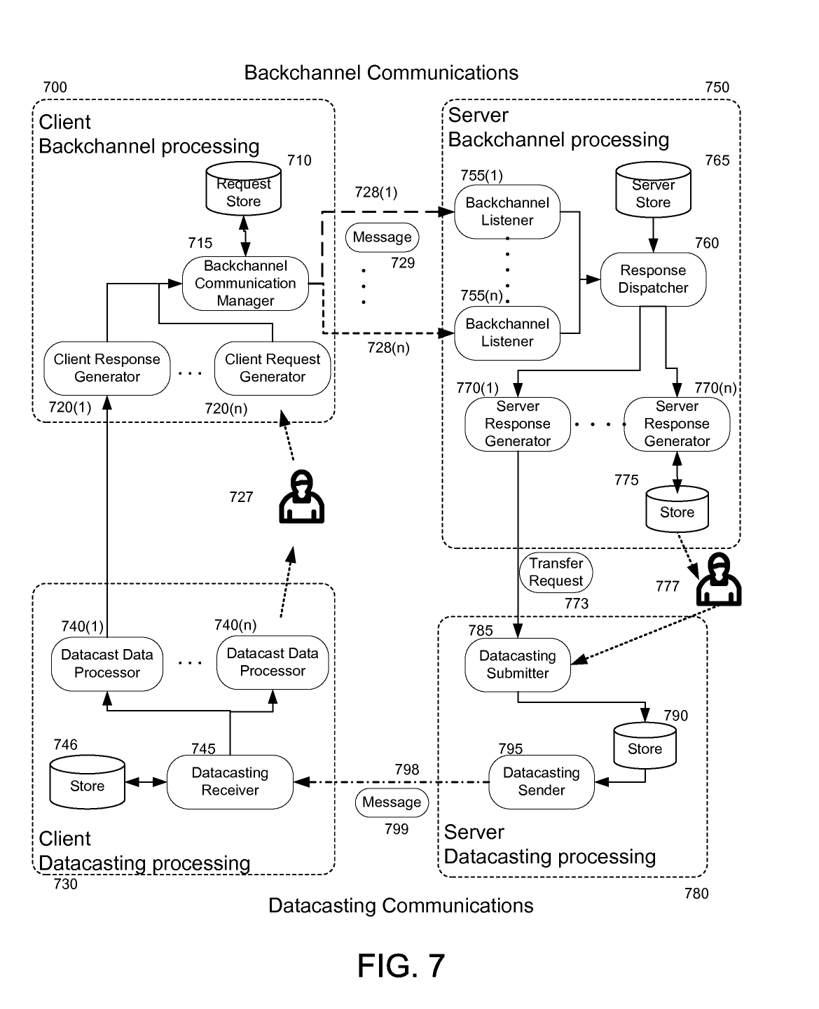

FIG. 7 illustrates in more detail a system combining a datacasting service over a broadcast communications medium with one or more backchannels according to embodiments of the present invention. In this embodiment, a backchannel can be used to request that data objects be datacast, and a backchannel message can be used to convey status in other than acknowledgment of receipt, such as a message indicating that a data object was processed successfully (or not) in some fashion, software installed using a data object, or a data object displayed to or read by a user.

Referring to the client backchannel processing 700 and FIG. 3A, a user 727 initiates a request for a particular data object, by means of an appropriate user interface, to one of a number of client request generator components 720(1) . . . 720(n) of the client device 101. The client request generator 720(n) processes the user's input to create a client request message (not shown) with the data object identifier (302). The client request message is provided by the client request generator to the backchannel communication manager 715. The backchannel communication manager 715 stores the client request message in the request store 710. When one of the backchannels 728(1) . . . 728(n) is available, the backchannel communication manager 715 reads and removes a request message from the request store 710 and sends it as a message 729 via an available backchannel 728(1) to the datacasting server 102 (303). Requests may also be initiated in response to other events and not just inputs by a user, for example in response to software instructions executed on the client device 101, or in response to an external or internal event, or to a scheduling event.

Referring to the server backchannel processing 750, the server datacasting processing 780, and FIG. 3B, the server 102 comprises a number of backchannel listeners 755(1) . . . 755(n) that each receives messages from a backchannel 104 (304). The backchannel listeners 755(1) . . . 755(n) render the messages to a format and provide them to the response dispatcher 760. The response dispatcher 760 determines from information of the messages and from information of the server 102, such as rules stored in the server store 765, the server response generator of a number of server response generators 770(1) . . . 770(n) to which the message should be provided—for example 770(1). In the case of a request message for a data object, the response dispatcher 760 obtains data of the data object from the server store 765 and provides the data of the data object and of the request message to the server response generator 770(1) that processes requests for messages (305). The server response generator 770(1) then generates a transfer request 773 for the data object, and provides it to the datacasting submitter 785 (306). The datacasting submitter 785 receives the transfer request from the server response generator 770(1), and stores it in a store 790. In this embodiment, the transfer request is stored in a queue structure. The datacasting sender 790 reads transfer requests from the store 790 and datacasts a message containing the data object 799 of the transfer request by means of the datacasting medium 798 (307).

Referring to the client datacasting processing 730, the client backchannel processing 700, and FIG. 4A, the data object 799 is received by the datacasting receiver 745 (401). The datacasting receiver 745 determines from metadata of the data object the appropriate datacast data processor 740(1) . . . 740(n). The datacasting receiver 745 provides the data object to the datacast data processor, in this example of a request for a data object to datacast data processor 740(n), which processes the data object (402), and in this example, displays information of the data object to the user 727 who initiated the request. An acknowledgment message may be created by a client response generator 702n) (403) and sent to the backchannel communication manager 715. When one of the backchannels 728(1) . . . 728(n) is available, the backchannel communication manager 715 sends the acknowledgment message via the available backchannel to the server 102 (404).

Referring to the server backchannel processing 750 and FIG. 4B, acknowledgment messages sent via backchannels 728(1) through 728(n) may be obtained by a backchannel listener 755(n) (405), processed by the response dispatcher 760, and subsequently the information of acknowledgment, such as the ACKCNT and data object identifiers, are stored in a store 775 (406).

In some embodiments, functions described as functions of a client device may also be implemented in the server or in another component, and vice versa. Further, transfer requests may be generated in response to an event. For example, a scheduler component may reside with the server 102, or with a client device 101, or with another component or system and submit a transfer request 773 to a datacasting submitter 785, according to a schedule Likewise, transfer request may be removed or data objects no longer datacast according to a schedule or in response to an event.

A user 777 may, by an appropriate user interface, examine data of the store 775 to review which data objects have been datacast or which data objects have been acknowledged. The user 777 may also submit transfer requests or other messages to the datacasting submitter 785, for example to start datacasting of a particular data object.

In some embodiments of datacasting systems, a client device 101 receives datacasting from a single sender. For convenience, this may be referred to as a client device 101 being “tuned” to a single sender. A single sender may be a physical transmitter sending a single datacasting signal, or the single sender may be a single channel broadcast by a physical transmitter or virtual transmitter. A channel may be a sub-channel of another channel, or may be a composite of a number of channels of a number of senders. For example, with mobile receivers that change location, with varying propagation conditions for a transmitted signal, or with interruptions in providing content for a particular sender, a given client device 101 at times may not be able to receive a datacast signal adequately from a particular sender, but might be able to receive datacasting content from another sender. In another embodiment, a client device 101 is capable of receiving from more than one sender. A second sender may datacast at least part of the same data content of a first sender, or alternative content. In others, a first sender and a second sender may provide identical content. Separate senders need not use the same formats, protocols, or provide the same level of service. A client device 101 may tune or re-tune to receive from a particular sender. In this context, tuning refers to the ability to receive selectively from any of a number of senders. In this context, station selection refers to a client device 101 or receiver tuning to a sender.

In one embodiment, a client device 101 has access to a data structure in storage with metadata that specifies to the client device 101 the stations to which it may tune. This is referred to as a station list. The station list may contain an array of key-value structures according to a schema. For example, a station channel number value may define the effective radiated power in watts, the height of the antenna (in feet) above ground level, and the location (in decimal latitude and longitude) of the physical transmitter used by the sender. A reference frequency (in Hertz) of the transmitter's signal may be defined. A list of code values for geographic area for which a sender datacasts information may be defined. A human-readable name for the DTV signal of the transmitter and the sender's datacasting signal used for a particular sub-channel of the transmitter's signal may be defined.

As a matter of design choice, metadata may be stored or accessed in other ways and forms, such as in a relational or non-relational DBMS, in files, in data structures in a memory, or in a distributed fashion, and may be fixed or variable. Metadata may also be implicit, such a set of receivable channels or senders identified by metadata provided in the signal of a transmitter and obtained by a client device from the metadata in the signal.

In some embodiments, a client device 101 has access to metadata comprising location information of the client device and location data of a number of senders in the station list. In other embodiments, the metadata of a sender may comprise other information, such as a definition of footprint area of a sender or an FEC characteristic of the sender's signal. The metadata may also comprise derived data, such as the strength of a signal received from the sender by the client, or data of a past history of reception, or metadata obtained from another source. The client device may tune to receive datacasts from a sender that meets a criterion determined from metadata of the client and metadata of one or more senders.

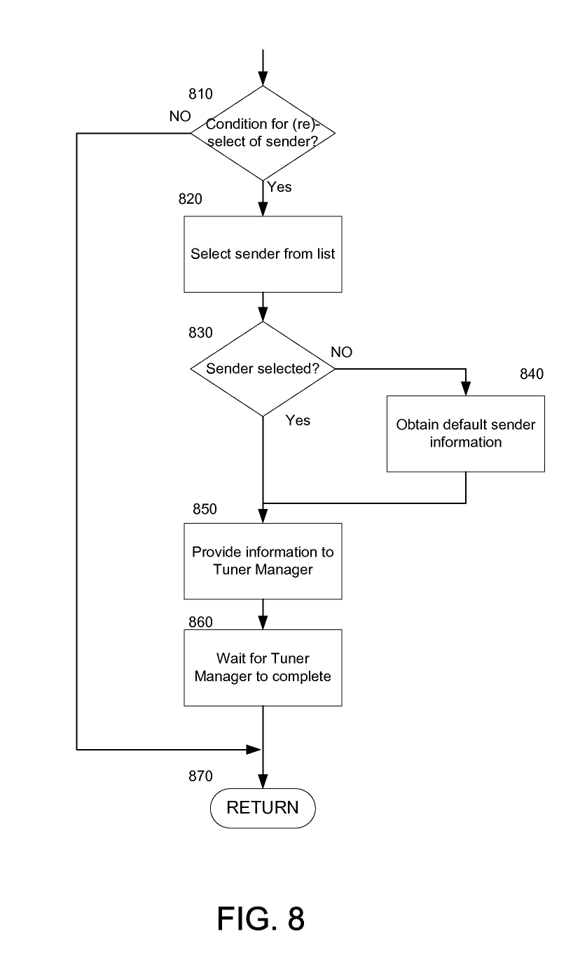

FIG. 8 illustrates a method for determining whether a sender should be (re)-selected and tuning to that seconder according to embodiments of the present invention. On a periodic, occasional or other basis, a should-select condition is evaluated to determine whether a sender should be selected (or reselected, in the circumstance at a sender is currently selected) (810). If the condition is not fulfilled, the method returns (870) with no sender (re)selected. If the condition is fulfilled, a sender is selected (820). If a sender has not been selected (830), default sender information is obtained (840). This may also be information to indicate that the current sender should not be changed, or that a different selection condition may be used. If a sender has been selected (830), information of the selected sender is provided to a tuner manager (850), a component that tunes the client device 101 to the selected sender. The process then waits for the selected sender to be tuned to (860).

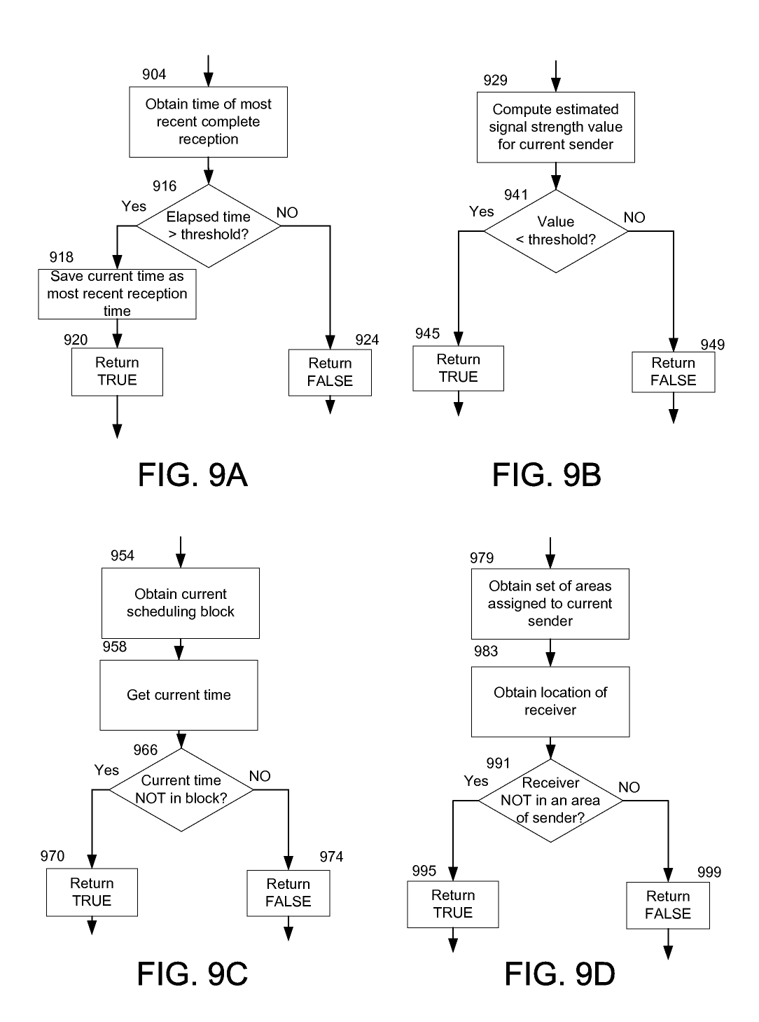

FIGS. 9A-9D illustrate exemplary conditions for determining that a sender should be selected according to embodiments of the present invention. Other conditions may be employed as a matter of choice, and conditions may be combined logically or in other ways. Referring to FIG. 9A, the time of the most recent successful reception of a complete data object is obtained from the present sender (904). How much time has elapsed since the most recent reception is then determined (916). If the time is within a threshold, FALSE is returned as the value of the condition (924), indicating that a sender should not be selected. If the time exceeds the threshold, the current time is stored as the most recent reception time (918), and TRUE is returned as the value of the condition (920), indicating that a new sender should be selected.

Referring to FIG. 9C, an estimated signal strength for the signal of the current sender is computed (929). The computation may be based on metadata of the sender such as its location, antenna height, and ERP, and metadata of the client device, such as its location. Whether the value is less than a threshold is then determined (941). If it is, TRUE is returned as the value of the condition (945), including that a new sender should be selected. If it is not, FALSE is returned (949), indicating that a new sender should not be selected.

Referring to FIG. 9C, the currently-determined schedule block for data objects being datacast is obtained (954). In this embodiment, a schedule comprises information describing a number of periods of time and sorts of data objects datacast by a sender within a particular period. A schedule block is the particular period of time in the schedule for a sender. The current client time is then obtained (958), and it is determined whether the current time is within the period of time of the schedule block or a time boundary of the schedule block has been crossed (965). If it has not been crossed, FALSE is returned for the condition (74), indicating that a new sender should not be selected. If it has been crossed, TRUE is returned (970), indicating that a new sender should be selected.

Referring to FIG. 9D, the set of areas of the current sender is obtained (979). The present location area of the client device is also obtained (983), for example by determining the location via a GPS component and deriving the current ZIP code for that location from published information of postal codes. It is then determined whether the client's current area is also an area of the current sender (991). If it is, FALSE is returned for the condition (999), indicating that no new sender should be selected. If it is not, TRUE is returned (995), indicating that a new sender should be selected.

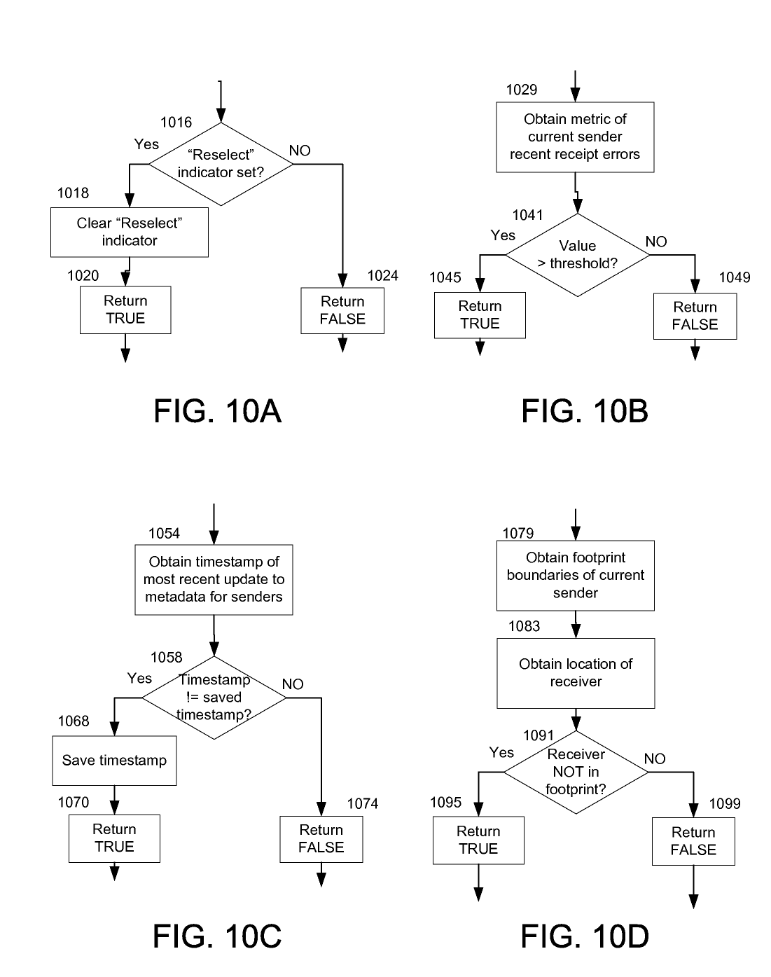

FIGS. 10A-10D illustrate further examples for determining that a sender should be selected according to embodiments of the present invention. Referring to FIG. 10A, it is determined whether a Reselect indicator has been set (1016). As a matter of design choice, this may be a flag set by software via an API, an indicator data structure set by an autonomous process, a flag representing the occurrence of an external or internal condition, or an indicator set in response to a user input via a UI, a compound object, or another form. If the indicator is set, the indicator is cleared (1018), and TRUE is returned (1020). If it is not set, FALSE is returned (1024).

Referring to FIG. 10A, a value that is a metric of receipt errors or success of the current sender is obtained (1029). For example, it may be a measure of the number of FEC error corrections or unsuccessful or missed receptions in datacast information received from the sender during a recent period of time. If the value exceeds a threshold (1041), TRUE is returned (1045). If the value does not exceed, FALSE is returned (1049).

Referring to FIG. 10C, the client device obtains a timestamp of the time of the most recent update to metadata of the station list (1054). For example, the station list may have been updated in response to a message, or user input, or action by another component. It is then determined whether the timestamp value is the same as a remembered timestamp value (1058). If it is not the same, the timestamp value of the update is saved as the remembered value (1058), and TRUE is returned as the value of the condition (1070). If it is the same, FALSE is returned (1074).

Referring to FIG. 10D, information of the boundaries of the signal footprint of the current sender is obtained (1079), and the present location of the client device is also obtained (1783). It is then determined whether the client device's location is within the footprint boundaries of the sender (1091). If it is not, TRUE is returned (1095). If it is, FALSE is returned (1099).

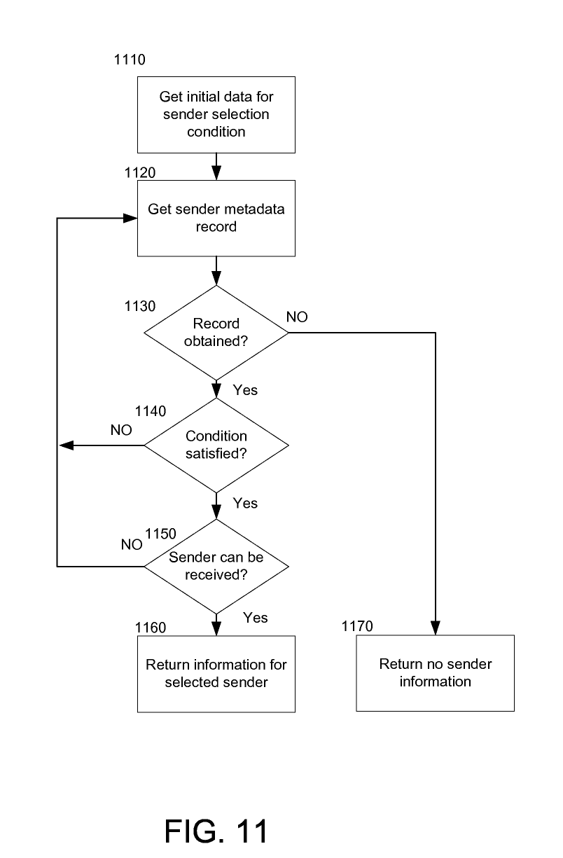

FIG. 11 illustrates a method for determining the selection of a sender according to embodiments of the present invention. In this embodiment, the method may be performed by the client device. An initial data for evaluation of a condition is obtained (1110), such as metadata of the current geographical location of the client device as determined by a GPS component, metadata of the history of reception success for the current sender, or other data. A record of metadata for a server is obtained from the station list (1120). If all such records had already been obtained, the method returns with no information of a sender (1170), indicating that no sender has been selected. If a record is obtained, the condition is evaluated to determine whether the sender of the record satisfies the condition (1140). If the condition is not satisfied, a next record of metadata for a server is obtained (1120). If the condition is satisfied, it is determined whether the signal of the sender can be received at the present time by the client device (1150). If not, the method continues at 1120. If so, the sender is selected, and information of the sender that has been selected is returned (1160).

Steps may be performed in various orders, may be combined, and steps may be optional as a matter of implementation choice. For example, the step of determining whether the signal of sender can be received may be omitted, or the step of determining whether the signal of the sender can be received may be performed separately. In some forms, the new sender selected may be the same sender as the current center.

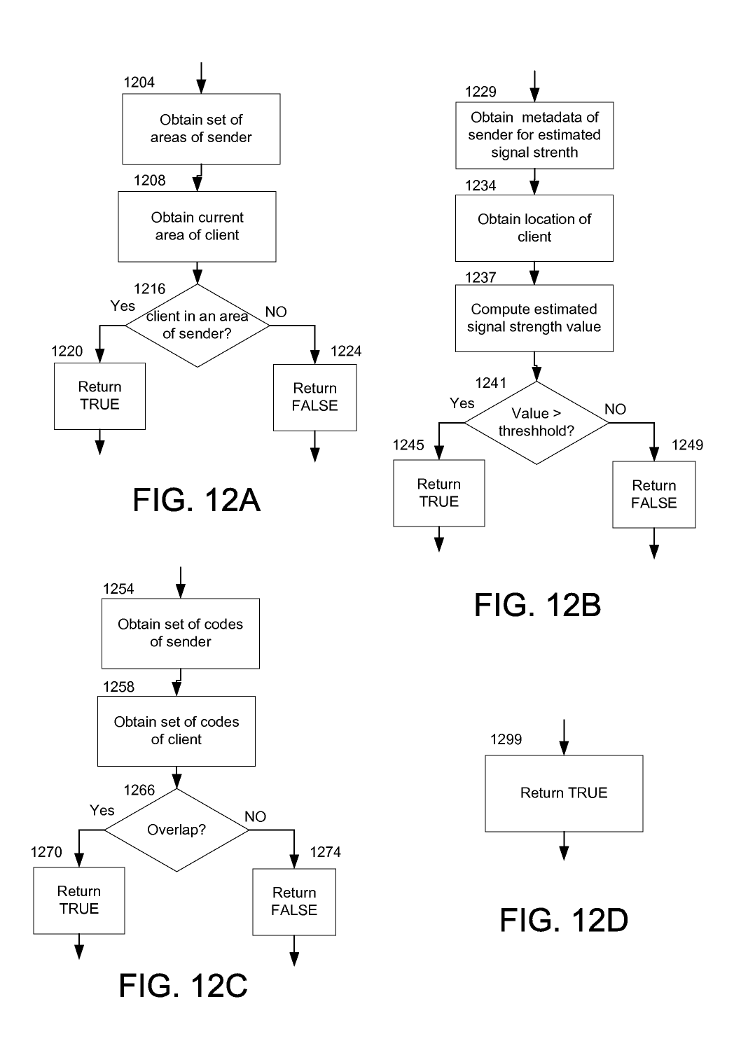

FIGS. 12A-D illustrate exemplary conditions for step 1140 of FIG. 11 according to embodiments of the present invention. Referring to FIG. 12D, TRUE may be returned (1299). In this embodiment, the sender selected may be the sender of the first metadata record obtained.

Referring to FIG. 12A, the set of areas associated with the sender of the metadata record is obtained (1204), and the location of the client device or the area of the client device's location is also obtained (1208). It is then determined whether the client's location or area is in an area of the sender (1216). If it is in an area of the sender, TRUE is returned (1220). If it is NOT in an area of the sender, FALSE is returned (1224).

Referring to FIG. 12B, metadata of the sender related to signal strength is obtained (1229), such as the location, ERP, height, and/or radiation pattern of the sender's transmitter, and at step 1734. Metadata of the location of the client device is also obtained (1234). An estimated signal strength value for the sender's signal at the client device is computed using a portion of the metadata (1237). If the value is above a threshold, TRUE is returned (1245). If the value is NOT above the threshold, FALSE is returned (1249).

Referring to FIG. 12C, a set of codes of metadata of the sender is obtained (1254). The codes may represent schedule information, content information, or other information as a matter of design choice. A set of metadata codes of the client device is also obtained (1258). It is then determined whether any code of the client device is also a code of the sender (1266). If this is so (i.e., the sets overlap), TRUE is returned (1270). If this is not so, FALSE is returned (1274).

The above descriptions are not limiting, and the form of implementation is a matter of design choice. For example, thresholds may be fixed or variable, and may be expressed negatively or positively. Values used in evaluating conditions may be discrete or not. Implementations may evaluate conditions such that the receiver is tuned to a sender which is near the location of the client device, or with the best estimated signal strength based on applying a power law such as inverse-square to metadata of the height of the transmitter and its radiated power and location with the location of the receiver, or to a sender with a different amount or configuration of FEC redundancy or able to provide service at a given level of datacast speed, or other conditions.

In some embodiments, the conditions may be such that the sender provides a desired sort of content, for example weather information. A sender may provide multiple sorts of content, and the content provided by senders need not be identical, or may overlap to a degree. In other embodiments, a client device may evaluate senders of the station list in a particular sequence. The sequence may be a complete sequence of all senders in the station list or a subset, may have repeated elements, and may be in a round-robin order or another order, an order based on history of reception, location information, or metadata of the station list, or other sequence. The selection of a sender may select the sender that most strongly fulfills a condition, or the condition may be a condition evaluated relative to other senders. Conditions may be combined. For example, the condition may be a combination of one or more of signal strength, particular datacast content such as containing information related to the clients current location, metadata information of the station list, or information from another source.

Forms and techniques for implementing the evaluation of conditions are a matter of design choice. Without limitation, the include using Boolean logic or programming, the evaluation of expressions in a mathematical form, algorithmic determinations, evaluation of rules or filters as is known in the art, and combinations of these and future techniques. In some implementations, it may be useful to store all or part of the logic in data structures in memory, or they may be read from a store.

In some embodiments, the receiver tunes to the same sender as long as a particular condition is fulfilled. When the condition is not fulfilled, the client may tune to a different station. Examples of the condition include loss of signal strength below a threshold for a period of time, or an absence of data being datacast. Signal strength may be determined in any fashion as a matter of design choice, such as signal level at a receiver's antenna, quality of reception with or without use of FEC, or based on historical information.

In some embodiments, information of a client's station list may be updated by information that is datacast. For example, this may comprise schedule information about when particular sorts of data objects will be datacast by senders, or information about the sorts of data objects datacast by a particular sender, location information, signal quality information, or other information, or a different list of senders.

In some embodiments, a receiver may receive datacasts from more than one sender concurrently, or may select or tune to more than one sender concurrently. The datacasts of senders may be related to a degree, such as datacasting a portion of the same information, or may be unrelated.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

Any of the mechanisms described above for the management and selection of the datacasting medium may also be applied to the backchannel medium without departing from the spirit and scope of the present invention. In these embodiments, the backchannel selection actions may be performed by the client or the server or both, either independently or cooperatively. Combinations of datacasting and backchannel medium management can be used to optimize one or more features of the closed-loop communications system such as but not limited to: bandwidth utilization, transmission latency, transmission coverage areas, eaves-dropping resistance, likelihood of error recovery, or power consumption.

What is claimed is:

1. A method for use of a backchannel with datacasting via a broadcast medium, comprising:
(a) creating by a server a message comprising a data object and a data object identifier associated with the data object;
(b) datacasting the message by the server via the broadcast medium to one or more client devices;
(c) receiving by the server one or more client messages comprising the data object identifier from one or more client of the devices via one or more backchannels; and
(d) recording by the server receipt of the one or more client messages for the data object identifier.

2. The method of claim 1, further comprising:
(e) receiving by a given client device the message datacasted by the server via the broadcast medium;
(f) processing the message by the given client device;
(g) creating by the given client device a given acknowledgment message comprising the data object identifier; and
(h) sending by the given client device the given acknowledgment message to the server via a given backchannel.

3. The method of claim 1, wherein the creating (a) comprises:
(a1) creating by a given client device a request comprising the data object identifier; and
(a2) sending the request by the given client device to the server via a given backchannel.

4. The method of claim 3, wherein the creating (a) comprises:
(a3) receiving by the server the request comprising the data object identifier from the given client device via the given backchannel;
(a4) processing by the server the request based on the data object identifier; and
(a5) creating by the server the message comprising the data object associated with the data object identifier and the data object identifier as a response to the request.

5. The method of claim 4, wherein the receiving (a3) comprises:
(a3i) determining by the server a given response generator to provide the request based on information comprised in the request and any rules stored at the server.

6. The method of claim 1, wherein the creating (a) and the recording (d) further comprise:
(a1) entering by the server a record with the data object identifier into a server store with an acknowledgment count set to an initial value; and
(d1) in response to receiving a given acknowledgment message from a given client device, incrementing the acknowledgment count.

7. The method of claim 6, wherein the one or more acknowledgment messages further comprise an identifier associated with the given client device, wherein the recording (d) further comprises:
(d2) logging by the server that the acknowledgment message was received from the given client device.

8. A non-transitory computer readable medium comprising computer readable program code embodied therein, wherein when executed by a processor causes the processor to:
(a) create by a server a message comprising a data object and a data object identifier associated with the data object;
(b) datacast the message by the server via the broadcast medium to one or more client devices;
(c) receive by the server one or more acknowledgment messages comprising the data object identifier from one or more client of the devices via one or more backchannels; and
(d) record by the server receipt of the one or more acknowledgment messages for the data object identifier.

9. The medium of claim 8, wherein the execution by the processor further causes the processor to:
(e) receive by a given client device the message datacasted by the server via the broadcast medium;
(f) process the message by the given client device;
(g) create by the given client device a given acknowledgment message comprising the data object identifier; and
(h) send by the given client device the given acknowledgment message to the server via a given backchannel.

10. The medium of claim 8, wherein the execution by the processor to create (a) is further executed by the processor to:
(a1) create by a given client device a request comprising the data object identifier; and
(a2) send the request by the given client device to the server via a given backchannel.

11. The medium of claim 10, wherein the execution by the processor to create (a) is further executed by the processor to:
(a3) receive by the server the request comprising the data object identifier from the given client device via the given backchannel;
(a4) process by the server the request based on the data object identifier; and
(a5) create by the server the message comprising the data object associated with the data object identifier and the data object identifier as a response to the request.

12. The medium of claim 11, wherein the execution by the processor to receive (a3) is further executed by the processor to:
(a3i) determine by the server a given response generator to provide the request based on information comprised in the request and any rules stored at the server.

13. The medium of claim 8, wherein the execution by the processor to create (a) and to record (d) is further executed by the processor to:
(a1) enter by the server a record with the data object identifier into a server store with an acknowledgment count set to an initial value; and
(d1) in response to receiving a given acknowledgment message from a given client device, increment the acknowledgment count.

14. The medium of claim 13, wherein the one or more acknowledgment messages further comprise an identifier associated with the given client device, wherein the execution by the processor to record (d) is further executed by the processor to:
(d2) log by the server that the acknowledgment message was received from the given client device.

15. A system, comprising:
a server for creating a message comprising a data object and a data object identifier associated with the data object and datacasting the message via a broadcast medium to one or more client devices; and
a given client device of the one or more client devices for receiving the message datacasted by the server via the broadcast medium, creating a given acknowledgment message comprising the data object identifier, and sending the given acknowledgment message to the server via a given backchannel,
wherein the server further receives the given acknowledgment message comprising the data object identifier from the given client device via the given backchannel and records the receipt of the given acknowledgment message for the data object identifier.

16. The system of claim 15, wherein the given client device further:
creates a request comprising the data object identifier; and
sends the request to the server via a second given backchannel.

17. The system of claim 16, wherein the server further:
receives the request comprising the data object identifier from the given client device via the second given backchannel;
processes the request based on the data object identifier; and
creates the message comprising the data object associated with the data object identifier and the data object identifier as a response to the request.

18. The system of claim 17, wherein the server further comprises one or more response generators, wherein the server further:
determines a given response generator to provide the request based on information comprised in the request and any rules stored at the server.

19. The system of claim 15, wherein the server further:
enters a record with the data object identifier into a server store with an acknowledgment count set to an initial value; and
in response to receiving the given acknowledgment message from the given client device, increments the acknowledgment count.

20. The system of claim 19, wherein the one or more acknowledgment messages further comprise an identifier associated with the given client device, wherein the server further logs that the acknowledgment message was received from the given client device.
